(19) United States
(12) Patent Application Publication
(10) Pub. No.: US 2005/0065824 A1
(43) Pub. Date: Mar. 24, 2005

(54) Data privacy management systems and methods

(76) Inventor: Mark Kohan, Plymouth Meeting, PA (US)

Correspondence Address: BAKER & BOTTS, 30 ROCKEFELLER PLAZA, NEW YORK, NY, 10112, US

(21) Appl. No.: 10/892,021

(22) Filed: Jul. 15, 2004

Related U.S. Application Data
(60) Provisional application No. 60/487,532, filed on Jul. 15, 2003.

(51) Int. Cl. G06F 17/60

(52) U.S. Cl. 705/3

(57) ABSTRACT

Systems and methods for processing and managing health care data records in a manner, which ensures compliance with privacy regulations governing the presence of personally identifiable information throughout all data management processes of an organization. The systems and methods involve use of a secure preprocessing environment to audit health care data records received from suppliers, to verify compliance and to encode non-compliant data fields in the data records. Encoding parameters that allow longitudinal linkability of the data records by individual are selected to replace personally identifiable information in the non-compliant data fields.

### CROSS REFERENCE TO PRIORITY APPLICATION

This application claims the benefit of U.S. provisional patent application Ser. No. 60/487,532, filed Jul. 15, 2003.

### BACKGROUND OF THE INVENTION

The present invention relates to the management of personal health information or data on individuals. The invention in particular relates to the assembly and use of such data consistent with maintaining individual privacy.

Personal medical information or data on individuals is commonly collected in computer databases for both commercial and non-commercial reasons. The databases can be used, for example, for epidemiological investigations. More often the databases are utilized for the efficient financial administration of medical services delivered to individuals. The use of computer databases is, for example, essential for conducting electronic transactions in the insurance industry.

The collection of personal information in a computer database that may be accessible or diverted to third parties risks misuse of the personal data. The increase in electronic means of doing commerce and the increase in public access, for example, to the Internet, increases the risk of data misuse.

Concern for the civil rights of individuals has led to government regulation of the collection and use of personal health data for electronic transactions. For example, regulations issued under the Health Insurance Portability and Accountability Act of 1996 (HIPAA), involve elaborate rules to safeguard the security and confidentiality of personal health information. The HIPAA regulations cover entities such as health plans, health care clearinghouses, and those health care providers who conduct certain financial and administrative transactions (e.g., enrollment, billing and eligibility verification) electronically. (See e.g., http://www.hhs.gov/ocr/hipaa). The regulations are designed to protect medical records and other individually identifiable health information in computers. Personal health information generally may not be used for purposes not related to health care. The rules are designed to promote electronic transactions. Yet the rules are complex: they are meant not to impede proper use of the personal information, but only improper use. For example, doctors, nurses and other providers generally have unrestricted ability to the share information needed to treat their patients. In some situations, covered entities may use or share only the minimum amount of protected information needed for a particular purpose. Individuals retain their rights to access their own medical records, to authorize use by other entities (not covered by HIPAA), and to complain of any misuse.

To protect the individual, federal regulations have outlined strict requirements around how identifiable patient data should be handled. Healthcare data providers have succeeded in meeting the regulations by either removing identifiable patient attributes from healthcare research data streams and/or by implementing their own process to “mask” the identifiable attributes.

However, masking identifiable attributes from health care data records has adversely affected research efforts that rely on the ability to track an individual across multiple data sources over time (commonly referred to as “Patient Travel” in the pharmaceutical industry and as “Longitudinal Patient Tracking” across the healthcare industry).

Safeguarding the security and confidentiality of personal information, whether by government mandate or by private initiative, is vital for the success of electronic commerce. Consideration is now being given generally to ways for safeguarding the security and confidentiality of personal health information collected in electronic databases. In particular, attention is directed to ways of collecting and using personal health information according to a set of rules, which discourage unauthorized use. The set of rules may, for example, be the government mandated HIPAA regulations. The desirable solutions are those that preserve individual patient privacy, but yet enable longitudinal tracking of the healthcare activities of an individual patient.

### SUMMARY OF THE INVENTION

In accordance with the present invention, systems and methods are provided for collecting and using personal information in databases in a manner consistent with a privacy management model for preserving individual privacy. The systems and methods involve the pre-processing, management, auditing and distribution of healthcare information in a manner that ensures patient confidentiality is protected throughout all data management processes of an organization.

In one embodiment of the invention, a system for pre-processing a healthcare data records file to ensure compliance with privacy regulations governing personally identifiable information in the data fields of the data records. The system includes a secure data processing environment for receiving and processing data record files from suppliers or vendors and applications for auditing supplier compliance with encoding requirements and regulations. In particular, data fields which are designated by HIPAA regulations as sensitive data fields (e.g., patient zip code, patient's date of birth, patient's age, transaction date, patient ID, and prescription number) are audited to verify the presence or absence of individually identifying content, and to accordingly determine a need for encoding the information content of select data fields. The system includes an encoding tool set to generate encoding parameters to replace the information in the selected data fields. The encoding parameters, which may be generated by random number generators, are designed to allow longitudinal linkability of the data records by individual without risking disclosure of individual identity.

The system maintains data file/attribute types and sizes through the preprocessing steps. The system also may include audit mechanisms for verifying compliance of the data field content with privacy regulations (e.g., HIPAA regulations), and mechanisms for testing the likelihood that the encoded information in the data fields could be used maliciously or accidentally to reveal the identity of an individual.

Further features of the invention, its nature and various advantages will be more apparent from the accompanying drawings and the following detailed description.

### BRIEF DESCRIPTION OF THE DRAWINGS

FIG. 1 is an illustrative diagram of a system for collecting and using healthcare information in databases in a manner consistent with a privacy management model, in accordance with the principles of the present invention; and

FIG. 2 includes a block diagram and flow charts, which schematically illustrate the processing of personally identifiable information data in a secure encoding environment designed to transform the information into de-identified longitudinal healthcare information while preserving individual privacy, in accordance with the principles of the present invention.

### DETAILED DESCRIPTION OF THE INVENTION

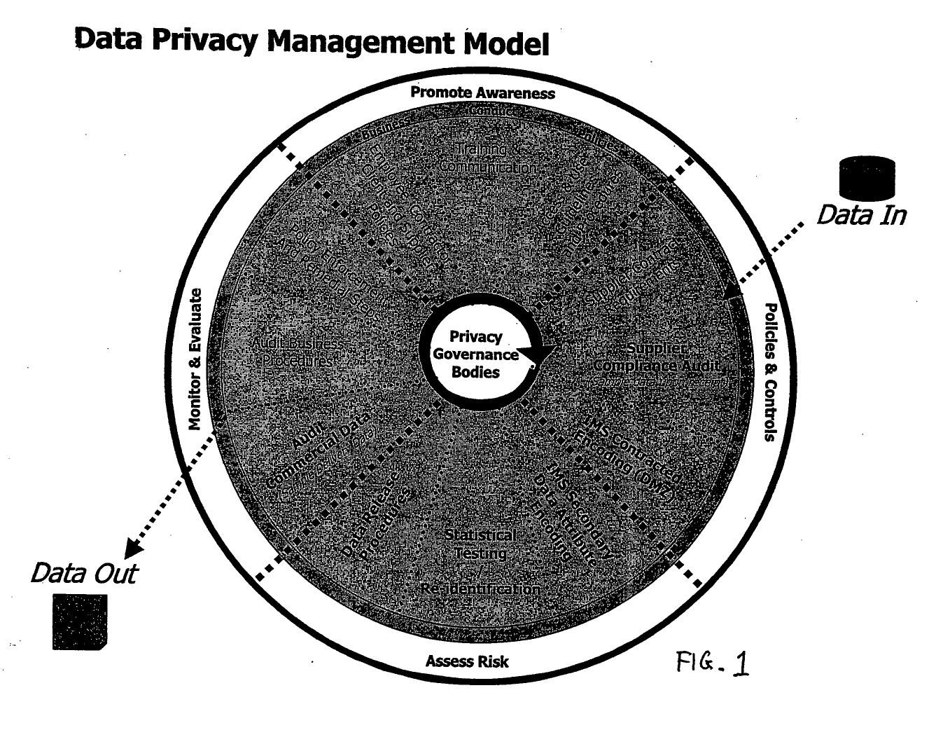

The invention is described in the context of the collection and processing of individual health information (e.g. patient information) from information suppliers in to an electronic database. The electronic database may be maintained by a Provider (hereinafter “Provider”) according to a suitable privacy management model (e.g., FIG. 1).

The information suppliers may be individuals, commercial contractors, hospitals or other entities collecting personally identifiable healthcare information. The information suppliers may be geographically diverse, and maybe electronically linked to the database, for example, over the Internet. The suppliers may supply data records on individuals in electronically transmitted data stream or data files. The data records may have specified data fields or attributes including some attributes that relate to the identity of the individuals. The Provider processes and suitably encodes the received data records to remove or disguise data attributes that may identify individuals. The encoded data records are assembled as de-identified records in the database in a manner, which maintains the longitudinal linking ability, by patient. The de-identified database records then may be provided to clients or other third parties for use consistent with rules for preserving the privacy of the individuals. The de-identified database records may be provided to clients electronically, for example, over the Internet.

The Provider may have information management and privacy policies or rules for the protection and use of information. The policies and rules may govern employee, information supplier (e.g. contractor) and client behaviors in both the providers' organization and at the client sites. The required behaviors under the policies may be arranged by agreement between the parties and may be undertaken as contractual obligations. Suitably agreed upon supplier policies may govern the data attributes that can or cannot be present in the data stream sent by the suppliers to the Provider. Corrective action plans or procedures may be invoked when non-conforming data attributes are received in the data stream. Collectively, these policies, procedures and contractual obligations may ensure that the data received by the Provider is properly de-identified prior to release into the data streams from which the Provider prepares records for use by third parties or clients. The Provider may train its employees on the proper use and protection of information under its information management and privacy policies. The Provider may further conduct continuing education sessions on evolving privacy regulations (e.g., HIPAA regulations) for clients, employees and/or suppliers.

Under the information management policies and rules, access to data by clients, employees and suppliers may be governed by documented procedures (e.g., “Access and Use Guidelines and Procedures”). These documented procedures may include suitable procedures (e.g., “Data Release Procedures”) that govern how data with different levels of individual-identifying attributes may or may not be released to a particular client. The Data Release Procedures may provide an organizational tool set, which may be used to determine what level and types of data access each employee, contractor or other party, is permitted. The Data Release Procedures may define varying levels of permitted access to the patient information according to the type of client. For example, authorized clients such as doctors may have greater access to individual data attributes than other clients such as insurance or marketing company. The Data Release Procedures may alert employees and contractors of the appropriate use and disclosure of patient information. The Data Release Procedures, also may define how access is permitted (via SFTP, VPN, Intranet, etc.), and how the data can be used based on supplier restrictions.

By contract with the information suppliers, the Provider may designate the data attributes that are acceptable in the incoming data streams received from the information suppliers. The Provider may not accept readily identifiable patient data from information suppliers or may accept such data only in limited circumstances. The data attributes received from the suppliers may be compliant with a set of rules, e.g., the HIPAA regulations. The Provider may accept only data that is HIPAA compliant. Alternatively, the Provider may accept data with individual-identifying elements or attributes, but may then process the data to encode these elements to ensure HIPAA compliance. In some instances, a data supplier may not have either the time, money, resources or desire to modify its systems to produce HIPAA compliant data. In such instances, under suitable contractual agreements and in conformity with HIPAA regulations, the Provider may make arrangements to encode the data supplier's data prior to the use of the data by the Provider. (See e.g., FIG. 1 Contracted (DMZ)). The Provider may engage an intermediate party (e.g., a neutral party) or a manual or automated processor to encode supplier submissions that contain readily identifiable readily identifiable patient data.

The Provider may conduct compliance audits to ensure that data sent by a supplier complies with the contractual requirements for data attributes. The audits may cover initial qualification of a new supplier. The new supplier qualification may involve auditing sets of data (e.g., data files) received from the new supplier during an initial qualification phase. All new supplier data files initially are checked to ensure that the data attributes transmitted to the Provider match the data attributes specified in the contract. These checks may include file layout and field formatting as well as checks to ensure that the Provider is not receiving readily identifiable patient data or HIPAA-protected fields. The initial auditing is designed to ensure that the data from the suppliers is compatible with and suitable for the data processing conducted by the Provider. The audit mechanisms include investigation procedures for any data that may be questionable. For example, any violations are reported to supplier management department and resolved with the data supplier. The Provider may request that data suppliers modify their data feed to match contractual requirements if the audit reveals non-compliant data. In some implementations of the invention, audit exception reports may be automatically generated notifying the Provider of potential HIPAA Privacy violations. The audit exception reports may, for example, flag instances where the data supplier states the data is going to be compliant but the Provider processes detect a data record as containing identifiable data. The Provider may itself make the non-compliant data record HIPAA compliant, if the errant data fields can be readily fixed or corrected. For example, the provider may automatically fix errors in data fields such as patient DOB, AGE and ZIP. If errors in other data fields or other issues are detected, receipt of the incoming data stream from the data supplier is stopped and the information secured until the issues have been resolved with the data supplier.

In addition to automated routine compliance checks on data feeds, data supplier data is periodically checked across time-periods (e.g., on a statistical sampling basis) to verify continued compliance. The audit checking may be renewed more intensively, for example, following any supplemental or updated privacy guidelines that may be provided to suppliers in response to evolving privacy regulations.

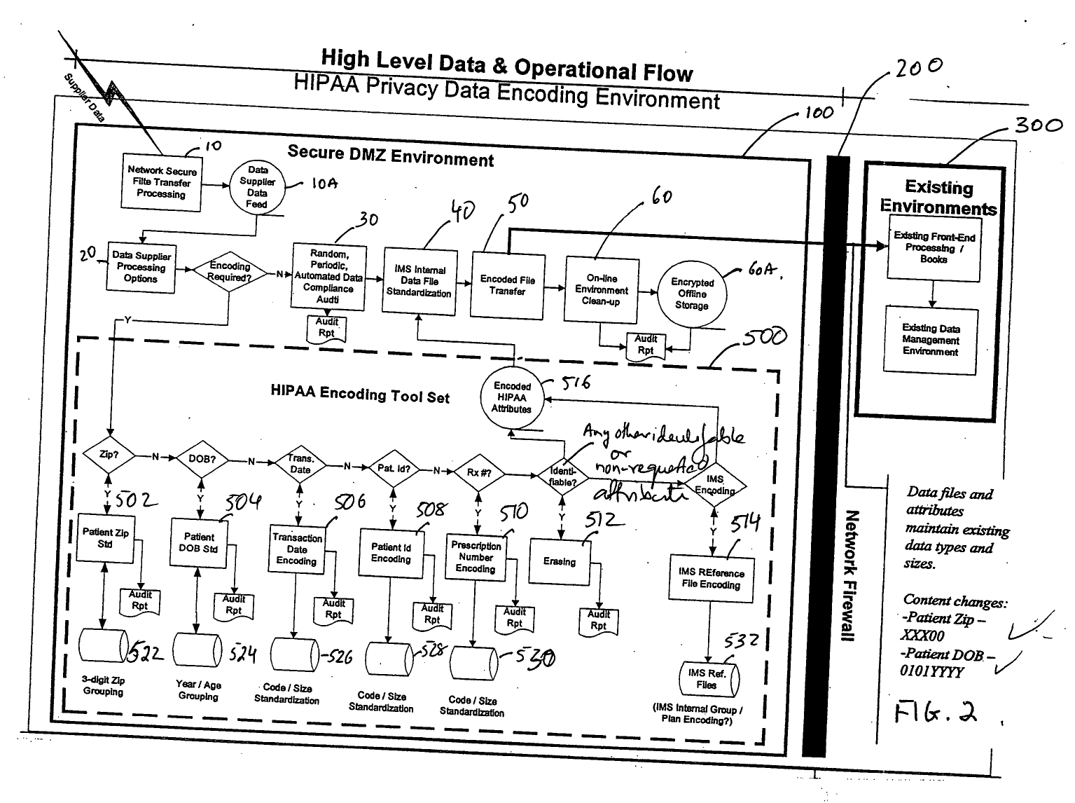

The Provider will pre-process data received from the suppliers in a secure data encoding and auditing environment (See e.g., a HIPAA preprocessing front end, FIG. 2 Secure DMZ Environment). This front end may precede all of the subsequent data processing components used by the Provider to compile data records in a database. The HIPAA preprocessing front end ensures that all HIPAA-protected health information is appropriately encoded by the supplier, neutral parties or the Provider itself. By this preprocessing, the Provider may ensure that all data elements provided by an information supplier comply with contractual, organizational and government requirements. All data records/files containing HIPAA-protected health information may be processed and audited by the HIPAA Preprocessing front end for purposes of de-identification of individuals prior to release of the data records into the Provider's subsequent data processing environments.

The Provider's subsequent data processing environments may include attaching provider-proprietary data attributes onto supplier data records, or replacing supplier supplied attributes in the supplier data records with provider-proprietary data attributes. For example, supplier's identification numbers for a physician or a pharmacy or other entity may be replaced with Provider generated internal identifiers (IN) assigned to that entity. The INs may be used to tag or identify the data records through the Provider's data processing and database. A proprietary reference file may be maintained listing entities or elements such as pharmacies, products, hospitals, prescribes, nursing homes, payers, plans, and processors, etc., by their corresponding IN numbers. This proprietary reference file of IN numbers may be used encode or reformat data records received from suppliers, to further minimize the risk of re-identification of individuals from the data records as they move through the Providers' data processing environment for production (e.g., to clients). The proprietary reference file of IN numbers is suitably protected to prevent misuse or inadvertent disclosure. The Provider generated IN numbers, which replace the data supplier identifiers, are used throughout the Provider's backend systems for processing the data records. Removal of the data supplier identification numbers from the data records provides an additional layer of de-identification on top of the data.

The Provider data records may be analyzed at one or more stages before production to assess the vulnerability of the data records to intrusive misuse that may expose, for example, patient identity. The analysis may involve manual or automated statistical testing of data records. The statistical testing may, for example, assess the likelihood that an intruder could determine the identity of a patient from the data received from a supplier by combining it with other readily available information. Additionally, the analysis may include automated checks of selected data fields of supplier data (e.g., HIPAA-sensitive fields such as the Patient ID) to verify the supplied data field values are not based on simple transformations of direct patient identifiers such as name or SSN, which can be easily decoded.

The database records that that are prepared or finalized through the Provider's data processing environments may be subject to audit prior to release, for example, as a commercial product to a client (See e.g., FIG. 1 Audit Commercial Data). The Provider's product development procedures may include a review of the end product to ensure that commercially released data is compliant with privacy regulations. The product development procedures include a review of customized deliverables that are developed on an ad hoc basis, and also of enhancements to existing products and services. The audits of the outgoing commercial data may be carried out by sampling on a suitable statistical basis.

The Provider also may periodically perform checks of various business procedures. The business procedures that are checked may, for example, include data privacy compliance, technology infrastructure, employment practices around data privacy, statistical testing methodologies, and data attributes. The Provider also may implement suitable internal operational procedures for policy enforcement and conducting remedial steps (See e.g., FIG. 1).

FIG. 2 shows an exemplary secure demilitarized zone firewall configuration (DMZ 100) that may be used in system implementations of the invention for encoding healthcare information to ensure compliance with HIPAA privacy regulations. A tool set 500 may be used to encode the data records. The data processing functions, tests and routines in DMZ 100 may be implemented using any suitable data processing hardware elements and software applications. The functions and applications in DMZ may for convenience in description referred to herein as blocks.

DMZ 100 may be used as a front-end interface between data suppliers and the Provider's data processing components 300 when the two are linked. DMZ 100 provides a secure, neutral zone that separates the Provider's internal networks from the external networks (e.g., Internet networks) used by the suppliers to feed data. Conventional hardware and/or software arrangements may be used to setup DMZ 100. For example, a firewall 200 separates DMZ 100 from components 300. External users such as suppliers may access FTP servers in the DMZ, but not the computers on the internal network or any computer performing the encoding processes. Other firewalls separating DMZ 100 from the external networks also may be used (not shown) to provide secure access.

FIG. 2 also shows (as a flow and block diagram) the exemplary data processing steps that may be carried out in DMZ 100 for implementing HIPAA encoding using tool set 500.

Block 10 represents the receipt of data files from the data suppliers over secure network links. The data fed or transmitted by the suppliers is represented by incoming data feed 10A.

Block 20 represents the evaluation of supplier data feed 10A to determine the degree of encoding required to bring the data attributes or format into conformance with Provider requirements or standards. The evaluation may include recognition of the incoming data encoding requirements that may be set forth in the contractual agreements between the Provider and an individual data supplier. Every data attribute where a common encoded format is expected is automatically subject to verification testing. If a data attribute is unexpectedly found to be non-complaint, it may be automatically processed and encoded by the Provider to be complaint. For each incidence of non-compliance, an exception report may be forwarded to the data supplier management for resolution and correction. For example, a data supplier may indicate that the patient-DOB data fields in the data records are HIPAA complaint. Yet, verification testing may indicate that the DOB-Month data attribute is not HIPAA compliant. In this case, DMZ 100 may use tool set 500 to automatically process data records to make the DOB-Month data attribute HIPAA complaint, and also automatically generate an a error message reporting the non-compliance incident to the data supplier's management.

In the usual cases where it is determined that no encoding is required based on either reliance on the data supplier contracts or automated verification testing, block 30 represents random, periodic and/or automated audits that may be conducted to verify continuing compliance of supplier data feed 10A with contractual or Provider standards. Block 40 represents the conversion or reformatting of the data feed 10A into a standard file format for further processing. The reformatting may include encoding the data records with data attributes 516. Next, block 50 represents the file transfer of the encoded data records across firewall 200 to the Provider's data processing components 300. Block 60 represents optional cleanup and encryption of the encoded records. The encoded records may be stored or archived in suitable storage devices. The encrypted data is represented, for example, by offline data store 60A.

If block 20 identifies the supplier of data feed 10A as requiring encoding, an encoding tool set 500 may be utilized to encode the data records. Tool set 500 may include tests for compliance of one or more data fields in data feed 10A. The tested data fields may include, for example, a patient's zip code, patient's date of birth (DOB), patient's age, transaction date, patient id, and prescription number. Tool set 500 may prepare standardized conforming attributes at blocks 502-510 to replace offending or non-compliant data fields. The attributes at blocks 502-510 may be prepared using, for example, standard stores or reference tables 522-530 which contain the encoding parameters for a patient's zip code, patient's date of birth (DOB), patient's age, transaction date, patient id, and prescription number.

Standard stores or reference tables 522-530 contain suitable encoding parameters for the subject data fields. For example, reference table 508 may contain a cross-reference between the patient IDs used by data suppliers and the corresponding Provider assigned patient IDs. Any suitable application (e.g., a random number generator) may be used to construct or maintain reference table 508 and the other standard stores or tables. Standard stores or reference tables 522-530 may be updated or supplemented as needed. For example, reference tables 508 and 510, that respectively contain encoding parameters for Patient ID and Rx Number, may be constantly updated by the application as new Patient ID and/or Rx Number data is received from a data supplier. In the instance a new Patient ID is received (e.g., “12345”) from a particular data supplier, the random number generator application may generate and assign a unique internal identifier (e.g., “87654”) as the encoding parameter for Patient ID 12345. All future occurrences of Patient ID 12345 in the data records received from the same data supplier may be encoded or replaced with the unique internal identifier 87654. This manner of encoding the Patient ID and/or the Rx Number (or any other identifiable healthcare identifier specified by the HIPAA regulations) preserves the longitudinal properties of the data records. For example, every time the same prescription is filled, the same unique internal identifier number is assigned to all data records concerning the prescription, thus keeping them linked together in the Provider's internal databases. The standard stores or reference tables are tightly secured and not accessible to the Data Suppliers and/or the Provider's backend processing network.

The applications that are used to construct or maintain stores and tables 502-512 may generate statistical counts of the update activity for quality assurance (QA) purposes. QA audit reports on batches of data received from data suppliers may be based on the statistical counts of the update activity required for each batch of data. A QA audit report for a particular batch of data received from a data supplier may indicate an unusual or statistically abnormal amount of update activity. In such an instance, the particular batch of data may be investigated or reviewed with the data supplier before it is accepted for further processing into the Provider's back-end processing applications. If the review or investigation reveals data corruption (e.g., of the patient ID attributes) in the data feed, the data supplier may be requested to send a new data file for processing.

In addition to encoding blocks 502-512, tool set 500 may optionally include a suitable test to verify that the encoded data field values and other data field values in the data records are robust and that they cannot be easily decoded or cracked to identify the patient. Tool set 500 may at block 512 identify or erase data field values that inadvertently contain identifiable data (e.g., patient's name placed in a comment field) and/or are not part of the legal document between the data supplier and Provider (e.g., attributes received from the data supplier but not requested by the Provider).

The set of standardized conforming attributes (e.g., patient Zip, Patient DOB, Transaction date, Patient ID, Rx Number) prepared by tool set 500 at blocks 502-512 are represented by encoded attributes 516. Block 516 may include information on other data attributes in data fields other than the five fields (e.g., patient Zip, Patient DOB, Transaction date, Patient ID, Rx Number). Encoding tool 500 may be configured to encode or overwrite any number of additional data attributes. Thus in the event that identifiable data is accidentally sent in a undesignated attribute, and/or if the data supplier sends attributes that have not been requested by the Provider, these attributes may be over written and indicated as such in block 516. In an exemplary instance of an actual data feed from a data supplier, the data feed included an unwanted attribute titled “Medical Device Number,” which is a protected HIPAA field. In this instance, an exemplary tool set 500 was advantageously utilized to overwrite the unwanted Medical Device Number field in every data record with blank spaces.

The HIPAA encoded attributes (block 516) generated by tool set 500 may be used for data file standardization at block 40. The original contents of a subject attribute in a data record (e.g., those containing personally identifiable information) are overwritten with the corresponding encoded attribute value indicated at block 516.

In addition to the HIPAA attributes, block 516 may also include Provider-proprietary data codes assigned to a physician or a pharmacy or other entity (e.g., provider-generated internal numbers INs). These internal numbers INs may be prepared by tool set 500 at block 514 using a reference file 532.

Although the present invention has been described in connection with specific exemplary embodiments, it should be understood that various changes, substitutions, and alterations apparent to those skilled in the art can be made to the disclosed embodiments without departing from the spirit and scope of the invention. For example, tool set 500 may be used to encode any type of health care record in addition or as an alternate to the exemplary pharmaceutical related healthcare records that have been used for purposes of illustration herein. Further, tool set 500 may be configured to test and encode any number and type of data fields or health care identifiers (e.g., in addition or as an alternate to the exemplary presscription number identifier that has been used for purposes of illustration herein).

1. A system for pre-processing a healthcare data records file to ensure compliance with privacy regulations governing personally identifiable information in the data fields of the data records, the system comprising:
a secure data processing environment for receiving and processing the data records file;
an application for auditing data fields in the data records to determine a need for encoding information in select data fields in the received data records to mask individual identity;
an encoding tool set disposed in the secure environment to generate encoding parameters for the selected data fields according to the determined need, wherein the encoding tool set comprises standard reference tables relating the individually identifiable information in the select data fields to select encoding parameters; and
an application for replacing the information in the selected data fields in the data records with the corresponding select encoding parameters.

2. The system of claim 1 wherein the select data record fields are data fields protected by HIPAA regulations.

3. The system of claim 1 wherein the select data records fields comprise at least one of patient zip code, patient's date of birth, patient's age, transaction date, patient ID, and healthcare identifier.

4. The system of claim 1 wherein the select encoding parameters are chosen to allow longitudinal linkability of the data records by individual.

5. The system of claim 1 wherein the encoding tool set further comprises an application for detecting personally identifiable information in non-standard data fields and erasing such personally identifiable information.

6. The system of claim 1 wherein the encoding tool set further comprises an application for detecting non-requested data fields and erasing such data fields.

7. The system of claim 1 wherein the encoding tool set further comprises applications for optionally encoding information in data fields in addition to the selected data fields, wherein the encoding tool set comprises standard reference file relating the information in the additional data fields to select encoding parameters.

8. The system of claim 1 wherein the encoding tool set further comprises applications for updating the standard reference tables in response to new values of individually identifiable information.

9. The system of claim 8 wherein the encoding tool set further comprises applications for auditing the frequency of updating activity.

10. The system of claim 1 wherein the secure data processing environment further comprises an application for auditing privacy regulation compliance of the data fields other than the select data fields for which a need for encoding information has been determined.

11. The system of claim 1 further comprising an application for testing the likelihood that the information in the data fields could reveal the identity of an individual.

12. A method for preprocessing a healthcare data records file to ensure compliance with privacy regulations governing personally identifiable information in the data fields of the data records, the system comprising:
using a secure data processing environment for receiving and processing the data records file from a data supplier;
auditing data fields in the data records to determine a need for encoding information in select data fields in the received data records to mask individual identity;
using an encoding tool set disposed in the secure environment to generate encoding parameters for the selected data fields according to the determined need, wherein the encoding tool set comprises standard reference tables relating the individually identifiable information to select encoding parameter; and
replacing the information in the selected data fields in the data records with the corresponding select encoding parameters.

13. The method of claim 12 wherein the select data record fields are data fields protected by HIPAA regulations.

14. The method of claim 12 wherein the select data records fields comprise at least one of patient zip code, patient's date of birth, patient's age, transaction date, patient ID, and healthcare identifier.

15. The method of claim 12 further comprising choosing the select encoding parameters to enable longitudinal linkability of the data records by individual.

16. The method of claim 12 further comprising checking for the presence of personally identifiable information in non-standard data fields and erasing such personally identifiable information.

17. The method of claim 12 further comprising checking for the presence of non-requested data fields and erasing such data fields.

18. The method of claim 12 further comprising encoding information in optional data fields in addition to the selected data fields and using a standard reference file relating the information in the additional data fields to select encoding parameters.

19. The method of claim 12 further comprising updating the standard reference tables in response to new values of individually identifiable information.

20. The method of claim 19 further comprising auditing the frequency of updating activity.

21. The method of claim 12 further comprising auditing privacy regulation compliance of the data fields other than the select data fields for which a need for encoding information has been determined.

22. The method of claim 12 further comprising testing the likelihood that the information in the data fields could reveal the identity of an individual.
